(19) United States
(12) Patent Application Publication
(10) Pub. No.: US 2016/0328984 A1
(43) Pub. Date: Nov. 10, 2016

(54) COMPUTER-IMPLEMENTED FRAMEWORKS AND METHODOLOGIES FOR ENABLING ADAPTIVE FUNCTIONALITY BASED ON A KNOWLEDGE MODEL

(71) Applicant: Smart Sparrow Pty Ltd, Surry Hills, (AU)

(72) Inventor: Dror BEN-NAIM, Surry Hills (AU)

(21) Appl. No.: 15/111,966

(22) PCT Filed: Jan. 13, 2015
(86) PCT No.: PCT/AU2015/000016

§ 371 Date: Jul. 15, 2016

(30) Foreign Application Priority Data
Jan. 16, 2014 (AU) 2014900131

(51) Int. Cl. G09B 5/12; G09B 23/00; G09B 7/00

(52) U.S. Cl. CPC G09B 5/125; G09B 7/00; G09B 23/00

(57) ABSTRACT

The present invention relates to computer-implemented frameworks and methodologies for enabling adaptive functionality based on a knowledge model. Embodiments of the invention have been particularly developed for providing an improved computer-implemented learning environment, for example in the context of generating, delivering and managing adaptive tutorials.

### FIELD OF THE INVENTION

The present invention relates to computer-implemented frameworks and methodologies for enabling adaptive functionality based on a knowledge model. Embodiments of the invention have been particularly developed for providing an improved computer-implemented learning environment, for example in the context of generating, delivering and managing adaptive tutorials. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Computer implemented learning platforms have become increasingly popular in recent years. Ongoing objectives relate to enhancing and enriching a user's learning experience, and various models have been developed in that regard.

### SUMMARY OF THE INVENTION

It is an object of the present invention to overcome or ameliorate at least one of the disadvantages of the prior art, or to provide a useful alternative.

One embodiment provides a computer implemented method for generating an interactive content item, wherein the interactive content item is to be accessed by a user of a client terminal, the method including:

commencing generation of an interactive content item;

defining one or more rules for the interactive content item, wherein each rule includes

(i) a trap state, which is realized when a set of trap state conditions are satisfied; and

(ii) a control instruction associated with the trap state, the control instruction being executed in the case that the trap state is realized; and

in respect of at least one of the rules, setting a trap state condition that is bound to a first specified knowledge data value defined in a knowledge model, wherein the knowledge model includes data indicative of a plurality of topic identifiers and, for each topic identifier, a knowledge data value associated with the user; and

in respect of at least one of the control instructions, defining a command to update a second specified knowledge data value in the knowledge model in a prescribed manner.

One embodiment provides a method wherein the knowledge model includes data indicative of a plurality of topic identifiers and, for each topic identifier:

(i) a knowledge data value associated with the user; and

(ii) respective knowledge data values associated with a plurality of further users.

One embodiment provides a method wherein the knowledge model includes data indicative of a plurality of topic identifiers and, for each topic identifier, a knowledge data value associated with the user, wherein each knowledge data value is indicative of the user's determined competency in respect of a topic described by the topic identifier.

One embodiment provides a method wherein setting a trap state condition that is bound to a specified first knowledge data value defined in the knowledge model includes any one or more of the following:

setting a trap condition that requires the specified first knowledge data value be greater than a threshold value;

setting a trap condition that requires the specified data first knowledge value be less than a threshold value; and

setting a trap condition that requires the specified data first knowledge value be equal to a threshold value.

One embodiment provides a method wherein the first knowledge data value defines the second knowledge data value.

One embodiment provides a method wherein each data knowledge data value is numerically defined.

One embodiment provides a method wherein the command to update the specified second knowledge data value in the knowledge model in a prescribed manner includes any one or more of the following:

a command to increase/decrease the specified second knowledge data value by a specified quantum;

a command to increase/decrease the specified second knowledge data value by a specified proportion; and

a command to selectively increase/decrease the specified second knowledge data value responsive to its current value.

One embodiment provides a method wherein at least one of the control instructions provides one or more of the following functionalities:

provide feedback to the user responsive to the specified first knowledge data value;

modify state data in an environment in which the interactive content item executes; and

direct the user to a specified further interactive content item.

One embodiment provides a method 1 wherein the interactive content item is a task defined in an adaptive tutorial.

One embodiment provides a method wherein the trap state conditions are defined by reference to either or both of:

(i) simulation state data for a simulation rendered at the client terminal; and

(ii) tutorial state data for an interactive tutorial rendered at the client terminal.

One embodiment provides a computer implemented method for managing an interactive content item, wherein the interactive content item rendered at a client terminal and accessed by a user, the method including:

monitoring state data at the client terminal;

maintaining access to a knowledge model, wherein the knowledge model includes data indicative of a plurality of topic identifiers and, for each topic identifier, a knowledge data value associated with the user;

operating a module thereby to coordinate implementation of one or more rules for the interactive content item, wherein each rule includes

(i) a trap state, which is realized when a set of trap state conditions are satisfied; and

(ii) a control instruction associated with the trap state, the control instruction being executed in the case that the trap state is realized; and

wherein, in respect of at least one of the rules, the trap state condition is bound to a first specified knowledge data value defined in a knowledge model, wherein the knowledge model includes data indicative of a plurality of topic identifiers and, for each topic identifier, a knowledge data value associated with the user; and

wherein at least one of the control instructions includes a command to update a second specified knowledge data value in the knowledge model in a prescribed manner.

One embodiment provides a method wherein the knowledge model includes data indicative of a plurality of topic identifiers and, for each topic identifier:

(i) a knowledge data value associated with the user; and

(ii) respective knowledge data values associated with a plurality of further users.

One embodiment provides a method wherein the knowledge model includes data indicative of a plurality of topic identifiers and, for each topic identifier, a knowledge data value associated with the user, wherein each knowledge data value is indicative of the user's determined competency in respect of a topic described by the topic identifier.

One embodiment provides a method wherein the a trap state condition that is bound to a specified first knowledge data value defined in the knowledge model includes any one or more of the following:

a trap condition that requires the specified first knowledge data value be greater than a threshold value;

a trap condition that requires the specified data first knowledge value be less than a threshold value; and

a trap condition that requires the specified data first knowledge value be equal to a threshold value.

One embodiment provides a method wherein the first knowledge data value defines the second knowledge data value.

One embodiment provides a method wherein each data knowledge data value is numerically defined.

One embodiment provides a method wherein the command to update the specified second knowledge data value in the knowledge model in a prescribed manner includes any one or more of the following:

a command to increase/decrease the specified second knowledge data value by a specified quantum;

a command to increase/decrease the specified second knowledge data value by a specified proportion; and

a command to selectively increase/decrease the specified second knowledge data value responsive to its current value.

One embodiment provides a method wherein at least one of the control instructions provides one or more of the following functionalities:

provide feedback to the user responsive to the specified first knowledge data value;

modify state data in an environment in which the interactive content item executes; and

direct the user to a specified further interactive content item.

One embodiment provides a method wherein the interactive content item is a task defined in an adaptive tutorial.

One embodiment provides a method wherein the trap state conditions are defined by reference to either or both of:

(i) simulation state data for a simulation rendered at the client terminal; and

(ii) tutorial state data for an interactive tutorial rendered at the client terminal.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

The term “tutorial”, as used herein, should be afforded a broad interpretation to encompass substantially any learning activity.

The term “tutorial”, in the context of a computer-delivered tutorial, as used herein, should be afforded a broad interpretation to encompass any computer process that delivers information including a series of tasks to be completed by a user. Examples include tasks delivered in the context of questionnaires, learning aids, practical/laboratory work (for example delivered in conjunction with virtual apparatus to replicate physical apparatus conventionally found in a laboratory), and other sets of tasks associated with learning of material (at any level from early childhood to post-graduate and beyond). However, embodiments need not be limited to tutorials delivered in the context of formal education. In some embodiments a computer-delivered tutorial is configured to provide feedback (for example adaptive feedback) to a learner. However, it is not necessary that the term tutorial, in a broad sense, carry with it any implied requirement for feedback,

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

The teachings herein build on the disclosure of a thesis entitled A Software Architecture that Promotes Pedagogical Ownership in Intelligent Tutoring Systems, by Dror Ben-Naim, School of Computer Science and Engineering, University of New South Wales, Sydney, Australia, August 2010. That document is incorporated herein in its entirety, and provided useful context and detailed teachings to assist persons skilled in the art in understanding and implementing technology disclosed herein.

### BRIEF DESCRIPTION OF THE DRAWINGS

Embodiments of the invention will now be described, by way of example only, with reference to the accompanying drawings in which:

FIG. 1 schematically illustrates a framework according to one embodiment.

FIG. 2A and FIG. 2B illustrate methods according to exemplary embodiments.

FIG. 3 illustrates a client-server arrangement that may be leveraged by various embodiments.

FIG. 4 illustrates a framework which makes of a knowledge model and rules engine.

FIG. 5A and FIG. 5B illustrate methods according to exemplary embodiments.

### DETAILED DESCRIPTION

Described herein are computer-implemented frameworks and methodologies for generating and delivering adaptive tutorials. Embodiments of the invention have been particularly developed for providing an improved computer-implemented learning environment. While some embodiments will be described herein with particular reference to that application, it will be appreciated that the invention is not limited to such a field of use, and is applicable in broader contexts.

### General Overview

The technologies and methodologies described herein relate to the generation, delivery and management of adaptive tutorials.

As used herein, the term “adaptive tutorial” refers to an interactive computer process which directs a user (student/learner) to complete a set of tasks. The sequence of the tutorial (for example the sequence of tasks, feedback provided and so on) is not predetermined; rather it is adaptive to individual users. More specifically, each task (referred to herein as a “question” or “tutorial question”) has a set of associated “trap states”. A “trap state” is defined by a set of conditions in global state data, and is realized when those conditions are met. For example, using very generic terminology, a trap state might be realized when “StateDataA=X” and “StateDataB>Y”. Each trap state has an associated control instruction, which is executed upon the realization of that trap state. For example, that control instruction might provide feedback to the user, or alter the learner's environment, or take the user to a particular different one of the questions, or update an internal value within the system.

In use, a tutor (or other form of author, which may in practice be substantially any user wishing to generate content) generates an adaptive tutorial. This is achieved using an authoring tool—a software product or module. The authoring process includes authoring adaptive tutorial content, for example by composing informational elements, defining tasks and authoring rules, trap states and control instructions. These are, in embodiment considered herein, able to be defined using a wide range of global state data, which includes both client state data (being data values that monitored from a client terminal during execution of the tutorial) and other state data values (for example data values available in or obtainable from local/or and third party data stores).

In terms of authoring rules, rules are optionally authored by several processes which can be conceptually distinguished. Firstly, rules may be authored in advance by reference to an informed anticipation of learners' potential mistakes and misconceptions. For example, a tutor considers ways in which students are likely to incorrectly complete a task, and then author defines trap states that target these expected incorrect approaches. Secondly, rules may be authored (or modified) after deployment of the content to learners. At that stage, a tutor may have access to reporting tools that present students' learning data, for example incorrect approaches that are actually being observed. Trap states may be authored to account for those. Alternately/additionally, the system may generate suggestions for such rules. Thirdly, a process may be implemented which automatically defines new rules based on data mining algorithms, which learn based on observed activity, and automatically generate new rules.

In embodiments described herein, an adaptive tutorial includes a plurality of tutor-authored tutorial elements (also referred to as sub-activities). A tutorial element can be broadly defined as falling into two categories—“information” and “tasks”—both may have a visual representation on a computer screen, or be otherwise delivered by a computer. “Information” elements can include multimedia information of various formats such as text, image, video, audio etc. A “task” may include an interactive element which the learner must work with in order, e.g: answer a question or complete a given task. For example, a paragraph of text is “information”, and a multiple choice question represents a “task”. The intention, in most embodiments, is that the task will be completed within the computer environment in which the tutorial is presented, but there can exist scenarios where tasks are completed in other computer-based environments (or, in some embodiments, outside of any computer environment).

When a learner interacts with an adaptive tutorial, tutorial elements are transmitted to a client terminal. Information on learner interaction is transmitted to the system's rule engine, which can execute either on the client terminal or the server. The rule engine is used to identify what trap states must be executed which causes control instructions to be implemented based on trap states rules.

A given trap state is realized when a set of trap state conditions are satisfied in a repository of global state data. For example, a “condition” is defined in logic that operates over state data. A rule engine is provided with a set of data (for example by referencing a location at which that data is accessible), and the condition, and if the condition is satisfied in the data, then the trap state is said to be realized, fired, or activated.

This repository of global state data includes both the client state data (monitored from the client terminal) and plurality of further state data values associated with the user, the tutorial and other system data. Those might include any one or more of the following:
Data derived from previous client state data. For example, this could include previous simulation state data, or previous tutorial state data.
Data derived from previous interactions between the user and the interactive tutorial. For example, this could include data indicative of a response to a current question in the interactive tutorial, data indicative of a response to a previous question in the interactive tutorial. This in some embodiments extends to include data indicative of a response to a question in another interactive tutorial.
Data derived from values defined in an independent system, including the likes of data derived from user behaviour in the independent system, or data derived from user attribute data maintained in the independent system.
Data indicative of user's likely ability to correctly complete a given task, or data indicative of proficiency of the user in relation to a specific topic. For example, this might be derivable from data maintained in a learner knowledge model.
Personal attributes of the user. For example, this may include academic information for the user (such as courses of study in which the user is enrolled, courses of study which the user has completed, and/or results for courses of study which the user has completed). This may also include general attributes, such as age of the user, sex of the user, nationality of the user, and proficiency of the user in a given language.
Data comprised of statistical information related to other users' performance in this tutorial, on this task or other related tasks. For example, a student may be informed that a number of other students have also had difficulty with a particular task, or another form of feedback might be applied responsive to the number of students who have failed at a particular task (that is, if most students are struggling with a task, that might indicate a systemic lack of mastery of a particular topic amongst a wider student group).
General worldwide data, including weather information and the like. For example, on a day where rain is forecast, the tutorial may be configured to remind a student to carry an umbrella, or a reference may be made to a recent sporting/news event.

This is by no means intended to provide an exclusive list.

By providing some of all of these varied states upon which to generate rules, a tutor is provided with the ability to generate a highly customisable adaptive tutorial in a streamlined manner. For example, a tutor is enabled to define rules that take into consideration, by way of example, how a learner has performed in previous questions and whether the learner has performed well in other courses relating to similar topics to a given question, and from that determine whether to provide feedback, direct the learner to simpler questions that will assist in learning a subject in respect of which the learner may have some knowledge gaps, or perform another action.

One embodiment provides a computer implemented method for enabling a tutor to generate an interactive tutorial for completion by a user. The method includes enabling (for example by means of a software application) the tutor to specify simulation data for the interactive tutorial, wherein the simulation data is indicative of a state-monitorable simulation (for example indicative of an internal state of a simulation that is monitored). The method further includes enabling the tutor to define a series of tutorial questions for the interactive tutorial. For each tutorial question, the tutor is enabled to define one or more trap states, each trap state being indicative of a set of trap state conditions in the repository of global state data (i.e. conditions that, when satisfied, result in the trap state being realised), and an associated control instruction that is to be applied to the interactive tutorial and/or the simulation in the case that the predefined state and the one or more data conditions are satisfied. In this manner, the user is enabled to operate a user interface that is configured to render the interactive tutorial including the simulation and the tutorial questions. The user interface operates in conjunction with a module that is configured to, upon determination that the trap state has been realized at the client terminal, provide the associated control instruction. This module optionally executes at a server remote of the client terminal.

Another embodiment provides a computer implemented method for managing an adaptive tutorial that executes at a client terminal operated by a user. The method includes monitoring client state data for a user interface executing at the client terminal. In some embodiments, as discussed further below, this is achieved by executing a Control Application Programming Interface (API), referred to herein as a “CAPI”. The client state data includes simulation state data for a simulation rendered at the client terminal, and tutorial state data for an interactive tutorial rendered at the client terminal. Based on the monitoring, the set of global state data for the user is updated. A set of rules is maintained for the interactive tutorial, wherein each rule includes data indicative of a trap state, and an associated control instruction that is to be applied in the case that the trap state is realized. A rules engine is configured to, upon determination that a trap state has been realized, implement the associated control instruction.

### Exemplary Framework

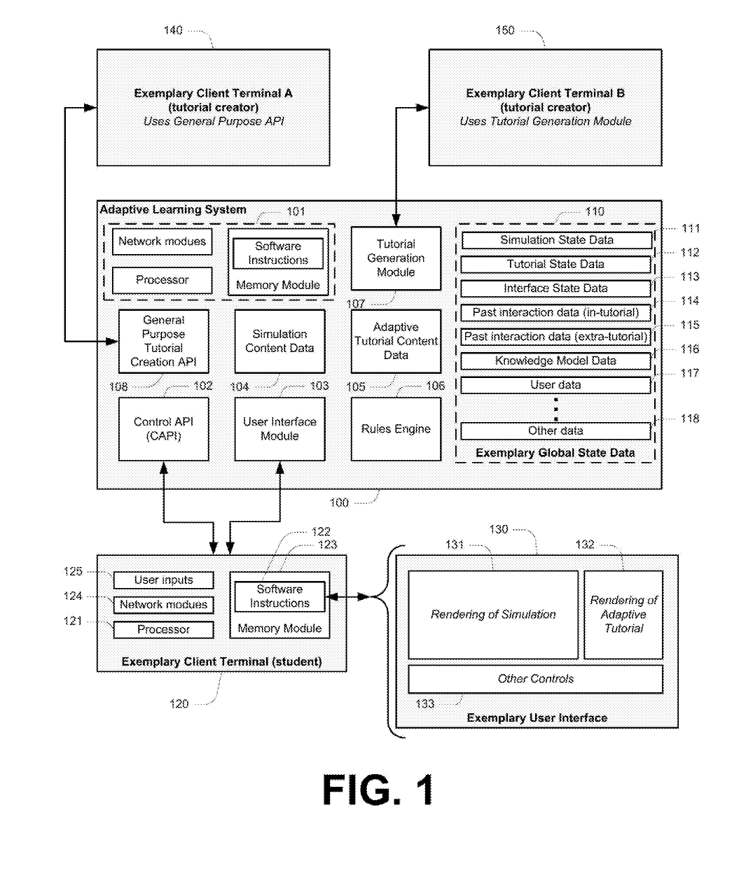

FIG. 1 illustrates a framework according to one embodiment, including various hardware/software components configured to provide functionality for various functionalities described herein. It should be noted that, although FIG. 1 illustrates a number of exemplary components, modules and functionalities, it is by no means necessary that all functionalities be present in a given embodiment. Rather, for the sake of efficient explanation, a number of optional features and functionalities are grouped together into the embodiment of FIG. 1. It should additionally be appreciated that any client-side software functionality could be wholly or partially provided as a server-side software functionality, and vice versa. For example, in a further embodiment the client-side functionalities are provided via a browser-based arrangement, and all substantive processing functionalities are performed at the server-side.

The embodiment of FIG. 1 is centred upon an adaptive learning system 100, which is in the illustrated embodiment defined by a server component, or alternately in further embodiments by a plurality of distributed servers and/or other computing components. System 100 is illustrated as including a generic set of hardware components 101, including a processor, a memory module configured to maintain software instructions executable on the processor (for example thereby to enable performance method as provide functionalities described herein), and network modules (for example Ethernet and/or wireless Ethernet components) which enable communication with other computing platforms, such as an exemplary client terminal 120.

In the illustrated example, system 100 is configured to provide an adaptive learning framework which is accessed and operated by a user of exemplary client terminal 120 (it will be appreciated that system 100 is configured to simultaneously interact with a plurality of such client terminals, of which only an exemplary one is illustrated). For example, a learner operates client terminal 120 thereby to engage in an interactive learning process provided via the adaptive learning framework.

In examples provided herein, the terms “student” or “learner” are synonymously used generally to describe a user of client terminal 120. Preferably, the student provides identification credentials thereby to identify himself/herself to system 100 as the user of client terminal 120. This may be manual, or automated (for example where the terminal/application self-identifies using available inherent data, or where credentials are otherwise stored thereby to negate a need for manual entering of credential data by a student) In this regard, various functionalities performed by system 100 are tailored to specific students. It is appreciated that the actual person operating terminal 120 might not, in practice, be the same person defined by provided identifying credentials. However, in operating terminal 120 they in practice take on the role of a learner in the context of the adaptive learning framework. It will be appreciated that it is preferable for a person operating terminal 120 to do so on the basis of their own identifying credentials, thereby to take advantage of aspects of individual personalisation that exist within the interactive learning system.

Although, in FIG. 1, components/modules of system 100 are herein described by reference with their relevance to exemplary client terminal 120, it will be appreciated that those components/modules are configured to operate in conjunction with multiple client terminals (either by the ability of a given module/component to handle multiple clients simultaneously, or by instantiation of multiple parallel executing software modules for handling respective client terminal sessions).

Client terminal 120 may take the form of substantially any computing device, such as a PC, laptop, tablet, smartphone, PDA, and so on. Client terminal 120 includes a processor 121, which enables the execution of software instructions 122 maintained on a memory module 123. These software instructions enable the rendering of an exemplary user interface 130 by device 120, and a user interacts with user interface 130 via user inputs 125 (for example including the likes a keyboard, mouse, trackpad, touchscreen, microphone, and so on). Network modules 124 enable client device 120 to communicate with system 100.

In some embodiments user interface 130 is provided via proprietary software (for example software downloaded and installed onto client terminal 120), and in other embodiments a browser-based approach is used whereby substantive code for user interface 130 is downloaded from a web server for rendering in a browser application executing at client terminal 120.

Exemplary use interface 130 is, in the context of FIG. 1, illustrated as a simplified exemplary screenshot. It will be appreciated that this has been simplified to show key conceptual graphical features only, and that in practice a user interface would have a different detailed visual appearance. The key graphical features are discussed below.

Block 131 represents a rendering of a simulation. The term “simulation” is used herein to describe any renderable object that is provided in the context of an adaptive tutorial. This could, in essence, be any form of computer executable content, being either dormant content (such as an image or text) or interactive content (such as an animation, model, video, or generally any form of interactive element). Substantially any form of content may be used as a simulation, provided that state data for the content, referred to herein as “simulation state data”, is able to be determined. The simulation state data is a set of data values that describe a current state of the simulation (and objects associated with or integrated within the simulation). It will be appreciated that the number and nature of values will vary between simulations and between content types. By way of example, the simulation may be an object that enables manipulation of a three-dimensional graphical object, and the simulation state data may include a current orientation (for example based on a set of X, Y and Z axis) of the object relative to a predefined origin. Another example is a simulation of a physical phenomenon, with appropriate controls having a human user to manipulate certain internal simulation data thereby change output variables of that simulation. The simulation may be rendered from data stored locally at client terminal 120, obtained from system 100, or obtained from another source.

Block 132 represents a rendering of an adaptive tutorial. This may include rendering one or more tutorial elements, for example tutorial elements that define information (for example text and/or other media), and tutorial elements defining tasks (for example questions). The term “task” is used in a broad sense, to encompass substantially any direction provided to a user via the adaptive tutorial, including a conventional question requiring an answer, a request to be completed, and instruction to perform an action, and so on. In some cases block 132 includes one or more fields in which the user is enabled to input data in response to a question. In some cases responding to a question includes interacting with the simulation. In some cases responding to a question requires a combination of interaction with the simulation and input of data in block 132. In some cases a “submit” or “check” button or the like is provided thereby to enable a user to indicate that a response to a question has been completed; in other cases user activity is monitored in real time, or in response to predetermined events and/or triggers, thereby to automatically monitor a learner's response (and/or partial response). In some cases feedback may be provided to the user via the adaptive tutorial in block 132.

User interface 130 also includes “other controls” 133, which are intended to generically represent any user interface controls and the like beyond simulation 131 and adaptive tutorial 132. It will be appreciated that the nature and complexity of other controls 133 varies significantly between embodiments.

User interface 130, is configured to make available client state data. This client state data includes:
simulation state data for simulation 131; and
tutorial state data for interactive tutorial 132.

There may be other aspects of client state date, for example based on states of other aspects of the user interface and/or client terminal more generally. The term “state data” refers to data that described a particular set of current conditions, for example in terms of data values. For example, where a simulation is a video object, the simulation state data may define a current timecode for the video (for example simulation.videotimecode=X:YZ). Where the adaptive tutorial includes fields configured to receive user-inputted data values, the tutorial state data may define data in those fields (for example tutorial.questionX.fieldYvalue=Z). It will be noted that these examples use an object-based nomenclature; the relevance of those to various embodiments is discussed further below.

System 100 includes a Control API (or CAPI) 102, which is configured to provide a link between client terminal 120 and system 100. In some embodiments separate modules are provided to enable communication between system 100 and the simulation, and between system 100 and the adaptive tutorial. Key functionalities provided by CAPI 102 include the following:
(i) Functionality to receive data from, and deliver data to, a user interface 130. This may include delivering tutorial data, simulation data, and or other data.
(ii) Functionality to monitor the client state data (including simulation state data for a simulation 131, and tutorial state data interactive tutorial 132). In this manner, CAPI 102 is used to enable control (e.g. inspection and manipulation) of data sources (tutorial elements, user interface controls, simulations, knowledge model, and so on), and provide data to other components, for example a server which executes the rule engine. In this manner, CAPI 102 provides a stream of state data to the rules engine, thereby to enable the rule engine to execute rules where predefined conditions (e.g. trap state conditions) are satisfied. For example, as discussed in more detail below, this is used to monitor for “trap states”, and implement control instructions associated with those trap states.
(iii) Functionality to control the simulation state data and tutorial state data. For example, this may include modifying simulation data thereby to manipulate the simulation to a different state, or modifying the tutorial state data to provide feedback, hints, or to provide a different question.

A user interface module 103 is configured to manage user interface data that is to be provided to terminal 120. This is primarily relevant in embodiments where the software instructions maintained at terminal 120 provide a placeholder for additional user interface data that is downloaded from system 100 as needed, for example where user interface 130 executes in a web browser that downloads user interface code from system 100.

Simulation content data 104 defines data for simulations available to be downloaded to client terminal 120. However, as noted, in some embodiments simulation content data is either maintained at terminal 120 or obtained from a source other than system 100.

Adaptive tutorial content data 105 includes data indicative of interactive tutorials that are configured to be provided via client terminal 120 and user interface 130. In some embodiments each interactive tutorial is defined by data including the following:
A set of tutorial elements, which may include information elements and task elements as discussed further.
References to one or more simulations (for example references to a unique identifier representing a simulation and/or a location, such as a URL, from which the simulation is obtainable). In some cases a simulation is referenced by a tutorial, and in other cases each individual question references a respective simulation. In some cases a tutorial does not reference a simulation, and hence the adaptive tutorial operates in isolation of a simulation.
A set of rules, execution of which being coordinated by a rules engine 106, as discussed further below.
References to other resources to be rendered along with the tutorial (for example references by way of URLs), such as images, video, audio, text, other HTML data, and so on.

In some cases a given tutorial has a predetermined start state (for example defined by initial state data and simulation data to be rendered in under interface 130), whereas in other cases a start state is determined by application of a given rule (and in this manner the start state may be different depending on characteristics of the student, thereby to provide a framework that is adaptive to particular students based on their characteristics).

CAPI 102 is used in order to monitor the client state data for user interface 130 executing at client terminal 120, and a set of global state data 110 for the user is updated, based on the monitored client state data, wherein the global state data additionally includes a plurality of further state data values associated with the user. In this example, global state data 110 includes:
Simulation state data 111. This may include current simulation state data, and historical simulation state data.
Tutorial state data 112. This may include current tutorial state data, and historical tutorial state data.
Interface state data 113. This includes other state data values monitored from interface 130, and again may include current and historic values.
Past interaction data (in-tutorial) 114. This includes data indicative of past interactions with the current interactive tutorial, for example results for earlier questions, and so on.
Past interaction data (extra-tutorial) 115. This includes data indicative of past interactions within the other interactive tutorials, for example results for earlier questions, and so on.
Knowledge model data 116. In overview, a knowledge model is defined to provide an indication of a user's competency in relation to a range of topics. Preferably this knowledge model is updated based on interactions with adaptive tutorials.
User data 117. For example, this may include academic information for the user (such as courses of study in which the user is enrolled, courses of study which the user has completed, and/or results for courses of study which the user has completed). This may also include general attributes, such as age of the user, sex of the user, nationality of the user, and proficiency of the user in a given language.
Data relating to other users, for example success/failure of other users in relation to a specific task (optionally in the form of statistics), average time for students to complete a given task, and so on.
Data unrelated to the tutorial, including data indicative of weather conditions, news events, sporting results, and so on.
Other data 118.

This is not intended to be an exclusive list of global state data, and is intended primarily to provide streamlined graphical explanation of indicative state value data types that may be used by system 100, or another such system.

As noted, adaptive tutorial content data maintains, for each tutorial, a set of rules. Each rule includes data indicative of a trap state, which is realized when a set of trap state conditions are satisfied in the global state data, and an associated control instruction that is to be applied in the case that the predefined trap state is realized. Rules engine 106 is responsible for implementing the rules. For example, during execution of a tutorial (or tutorial question), the applicable rules are loaded into memory. Upon determination that a trap state has been realized, the rules engine executes the associated control instruction.

System 100 additionally includes a tutorial generation module 107 that is configured for enabling a user of an exemplary client terminal 150 to generate (i.e. author) an adaptive tutorial. For example, this provides an interactive software environment that enables a user of terminal 150 (referred to as a “tutor”) to nominate simulations, generate questions, define rules, trap states, and control instructions, and so on. This is discussed in more detail further below.

Additionally, a general purpose tutorial creation API 108 enables a user of another exemplary client terminal 140 to generate an adaptive tutorial by other means. For example, the API defines how an adaptive tutorial is to interact with CAPI 102, thereby to facilitate interaction with system 100 and sharing of client state data. This may be used to enable a programmer to create a computer program that operates generally independently of system 100, but which provides adaptive functionalities by way of interaction with system 100 (including, but not limited to, adaptive feedback, difficulty, messaging, presentation, pace, and so on). The API defines the manner by which the created computer program interacts and shares data with system 100 thereby to enable the provision of such adaptive feedback functionalities.

### Exemplary Methods

Exemplary methods performed using the framework of FIG. 1, or an alternate framework having similar characteristics are discussed below. These are “computer implemented methods” in the sense that they are performed by way of executing computer readable code (i.e. software instructions) via one or more microprocessors of a computer system.

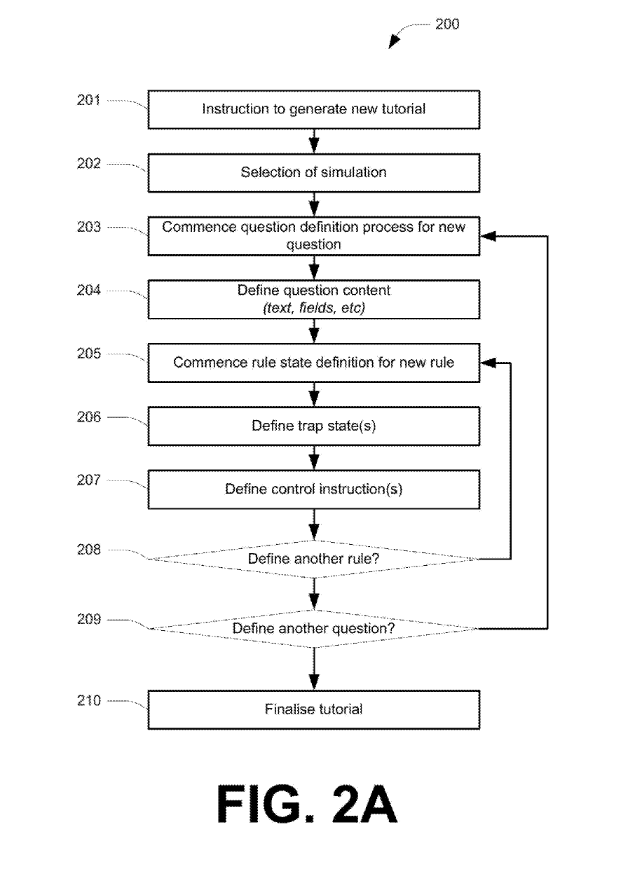

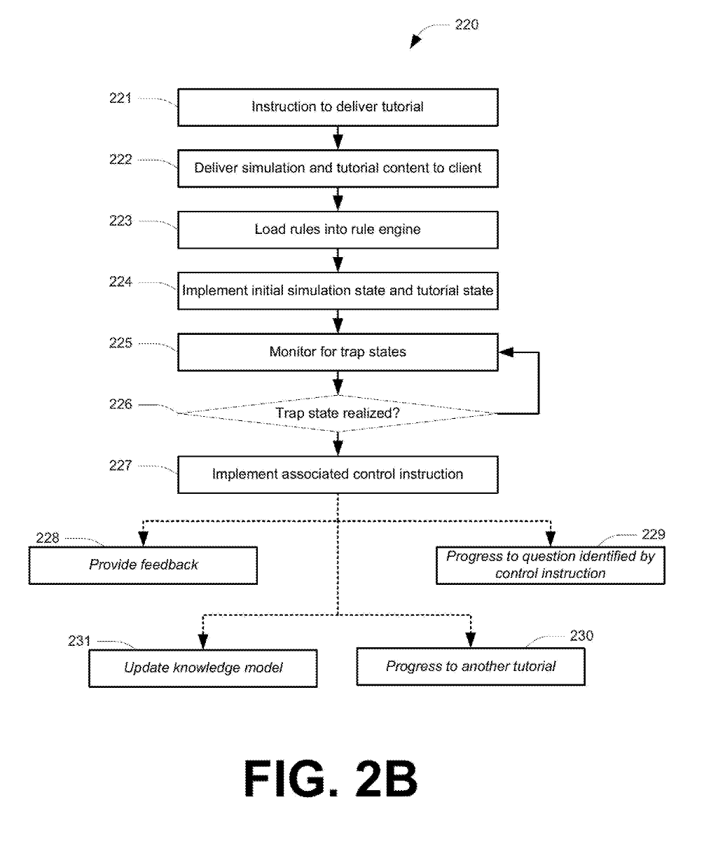

FIG. 2A illustrates an exemplary method for generating an adaptive tutorial according to one embodiment. FIG. 2B illustrates an exemplary method for managing an adaptive tutorial.

### Exemplary State Data Coordination

In some embodiments an object-based approach is used for the purpose of coordinating the management of state data values. For example, a root object is defined for each user, and other values nested at lower levels beneath that root.

So as to provide a simple practical example, assume the root level is defined as USER. Beneath that level, objects are defined for simulation state data, tutorial state data. These are defined by USER.SIMULATION and USER.TUTORIAL respectively. These have state respective values, for example Value1 to ValueN. These are represented, for instance, as USER.SUMULATION.VALUE2 or USER.TUTORIAL.VALUE5. For the purpose of this example, we shall assume that the global state data values also include values relating to a knowledge model USER.KNOWLEDGEMODEL, which has values for mastery of certain topics TOPIC1 to TOPICN. Further assume that the global state data includes values for past interaction with the present tutorial, specifically in terms of whether other questions were correctly answered. These are defined as a SCORE for each QUESTION in the TUTORIAL, hence represented by, for example USER.TUTORIAL.QUESTION1.SCORE.

Using the above nomenclature, indicative trap states for a given question might be defined as follows:

Trap State 1:
USER.SIMULATION.VALUE1=XYZ; and
USER.SIMULATION.TUTORIAL.VALUE1>0; and
USER.KNOWLEDGEMODEL.TOPIC6>5; and
USER.TUTORIAL.QUESTION1.SCORE=1

Trap State 2:
USER.SIMULATION.VALUE1=XYZ; and
USER.SIMULATION.TUTORIAL.VALUE1>0; and
USER.KNOWLEDGEMODEL.TOPIC6≦5; and
USER.TUTORIAL.QUESTION1.SCORE=1

Trap State 3:
USER.SIMULATION.VALUE1=XYZ; and
USER.SIMULATION.TUTORIAL.VALUE1>0; and
USER.KNOWLEDGEMODEL.TOPIC6≦5; and
USER.TUTORIAL.QUESTION1.SCORE=0

It will be appreciated that similar trap states have been defined. In fact, all three trap states relate to a common simulation state and tutorial state, indicating that they are all applicable in the case of the same response to a given question (which we shall assume to be incorrect for the present circumstances). The differences are in knowledge model data value for TOPIC6 and score values for QUESTION1. For the sake of this example, assume that knowledge model values increase with competency in a given topic, and that question scores are 1 where a question is answered correctly without substantive assistance or 0 where a question is either not correctly answered, or answered with substantive assistance (through feedback). In this manner, trap state 1 indicates that the user has incorrectly answered the question but has competency in a relevant topic and has answered a certain earlier question correctly. Accordingly, the associated control instruction might be simply to “try again”. Trap state 2 indicates a lower than threshold competency in the relevant topic, but a successful attempt at a previous question. Hence, the control instruction might be to provide a hint, for example by adjusting the simulation into another simulation state and providing by way of textual suggestions via the interactive tutorial. Trap state 3 indicates a lower than threshold competency in the relevant topic, and an unsuccessful attempt at a previous question. Accordingly, the control instruction might be to direct the user to a series of questions intended to build competency in, for example, TOPIC6, thereby to increase the chance of the user successfully completing the question on a later attempt.

It will be appreciated that, in accordance with embodiments discussed herein, each rule is defined by an “IF” portion, defined by a trap state, and a “THEN” portion, defined by a control instruction associated with the trap state. Preferably there is a 1:1 relationship between trap states and control instructions.

### Knowledge Model

Embodiments of the technology described herein also relate to the implementation of a knowledge model, for example in the context of using a knowledge model in the context of generating and/or managing interactive content items. For example, these interactive content items may be tasks/questions in the context of an adaptive tutorial as described above. However, knowledge model relate embodiments are not necessarily limited to application in the context of adaptive tutorials.

The embodiments described herein are focussed on enabling a user to leverage a knowledge model when authoring content items for adaptive tutorials, so that the behaviour of a given content item may be influenced by data in the knowledge model. For example, a given student response may invoke two different control instructions based on the knowledge model data This is differentiated from known systems, which use knowledge-model-like data to facilitate selection and/or ordering of tasks in the context of a multi-task tutorial.

The term “knowledge model”, as used herein, describes a repository of information (for example a database) that includes data indicative of a plurality of topic identifiers and, for each topic identifier, a knowledge data value associated with the user. Preferably the knowledge model includes knowledge data values for a plurality of users. The topic identifiers describe topics, for example subjects, concepts, and so on. Preferably the knowledge model supports a flexible framework for defining topics, enabling both broad topics (for example “trigonometry”) to narrow topics (for example “senior high school level application of cosine function”). In some embodiments an independent management authority is responsible to managing topics and topic identifiers thereby to provide consistency for a plurality of content-generating users. In some embodiments content-generating users are enabled to define new topics/topic identifiers to meet their specific needs.

The manner by which a knowledge model is organised varies between embodiments. For example, in some embodiments the knowledge model is a relatively simple database, which provides knowledge data values for each user in respect of each topic identifier. In some embodiments relationships are defined between topics, such that a change in knowledge data value for one topic has a follow-through effect to other topics. For example, topics may be defined in tree structures, with upward aggregation through each tree structure (e.g. an increase in a knowledge data value for “senior high school level application of cosine function” may provide a corresponding increases for “trigonometry”).

The term “knowledge data value” refers to a value, which need not be a numerical value. Preferably a value definition protocol is consistently defined across the knowledge model. In broad terms, a knowledge data value is used to make a prediction as to a user's proficiency in a given topic relative to a known scale. This may be a numerical scale, a scale defined by plan-language descriptors (e.g. “no knowledge”, “some skill”, “observed high-level proficiency”), or substantially any other scale.

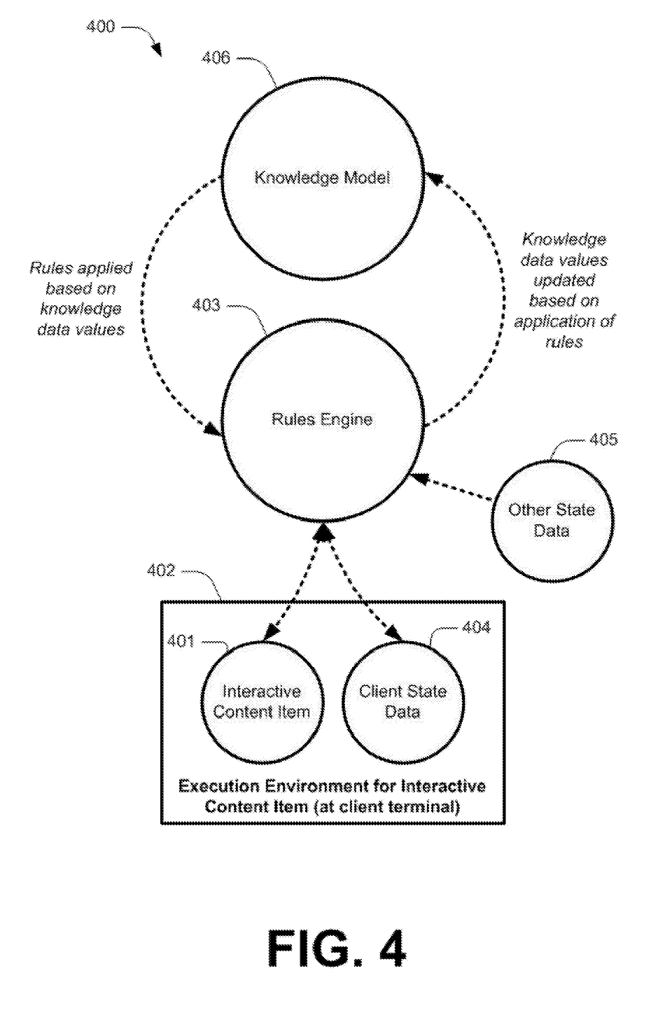

FIG. 4 illustrates an arrangement 100, which outlines implementation of a knowledge model according to various embodiments. In overview, a content-generating user generates an interactive content item 401, which executes in an execution environment 402 at a client terminal. For example, the interactive content item may be defined by an object, or collection of objects, that execute in a web browser application at the client terminal. A component that provides a rules engine 403 (which is optionally provided at a remote server) monitors the interactive content item 401 and client state data 404. In some cases other state data 405 is also monitored. This monitoring, in some embodiments, enables identification of trap states as discussed in preceding sections.

In identifying trap states, rules engine 403 is also responsive to data in the knowledge model, such that rules are applied based on knowledge data values. For example, trap states are defined by reference to the knowledge model. A sample trap state rule might take a form such as “knowledge data value for topic ID “Trig123” is greater than X”. In that regard, a trap state might be defined by a plurality of “IF” requirements, of which one is defined by reference to a specific knowledge data value in the knowledge model. In some cases a knowledge data value is the only IF requirements distinguishing two trap states, enabling different functionality to be applied in a common situation depending solely on the knowledge model's data concerning the user's proficiency in a specific topic. For example, in the context of an interactive tutorial, this might be used as a determining factor to decide between providing feedback, providing assistance (for example by changing simulation state data), directing the user to another tutorial question or tutorial, and so on.

The relationship between the rules engine and the knowledge model is two-way. Specifically, in addition to applying rules based on knowledge data values, knowledge data values are updated based on the application of rules. This is optionally achieved by way of “THEN” operators in rules. For example, a THEN command (being a control instruction, or operation of a control instruction) associated with a trap state may include an instruction to update a specified knowledge data value in a prescribed manner. In very simple terms, a knowledge data value might be increased if a question is correctly answered on a first occasion, or decreased if a user is unable to successfully complete a task. It will be appreciated that the precise manner in which knowledge model control instructions are defined depend on specific implementation aspects and protocols associated with the knowledge model.

In relation to the generation of interactive content items, one embodiment provides a method as follows. The method begins with commencing generation of an interactive content item. This may include defining content, selecting simulations, and/or other actions. Then, one or more rules are defined for the interactive content item. Each rule includes: (i) a trap state, which is realized when a set of trap state conditions are satisfied; and (ii) a control instruction associated with the trap state, the control instruction being executed in the case that the trap state is realized. In respect of at least one of the rules, a trap state condition is set to be bound to a first specified knowledge data value defined in a knowledge model. Furthermore, in respect of at least one of the control instructions, a command is defined which causes an update in respect of a second specified knowledge data value in the knowledge model in a prescribed manner.

In the context preceding paragraph, it may be that the first knowledge data value and second knowledge data value are the same (i.e. relate to the same user and topic identifier). This enables the interactive content item to provide interactivity responsive to proficiency in a given topic, and subsequently influence the data value representing the user's proficiency in that topic. In other case the cause and effect aspects are cross-topic.

In some cases, the trap state condition is set by reference to a relationship, to a threshold value (greater than, less than, equal to, and so on). This provides an approach that is straightforward to implement for a content generator, by effective nevertheless. For example, when defining rules, a content generating rules is able to define trap states that include conventional operators tied to values in the knowledge model, thereby to control interactivity/adaptation responsive to end user knowledge.

A key aspect of the embodiments of technology described herein is that the knowledge model is updated on application of the rules, thereby resulting in a circular self-improvement mechanism illustrated in FIG. 4. That is, there is no need for a large amount of preliminary setup to define user knowledge; interaction between users and content items (for example adaptive tutorials) inherently allows the knowledge model to grow.

In some embodiments the command to update the specified second knowledge data value in the knowledge model in a prescribed manner includes commands to increase/decrease a specified second knowledge data value by a specified quantum, by a specified proportion, or by a quantum/proportion defined relative to its current value. In some cases there is no reference to the current value, and the control instruction is indicative of a new value. For example, in the context of an adaptive tutorial task, a rule may be defined whereby, if a student arrives at a certain trap state, that indicates a clear lack of understanding of a particular concept, and the control instruction is configured to update the knowledge model accordingly. This may subsequently be used to direct a student to tasks designed to increase understanding of that concept, and/or prevent the student from attempting tasks requiring mastery of that concept until the relevant knowledge model data value has been adequately improved.

More broadly, the control instruction may be used to provide feedback to the user responsive to the specified first knowledge data value, modify state data in an environment in which the interactive content item executes, direct the user to a specified further interactive content item, and/or a range of other functionalities.

In some embodiments, where a knowledge model is used in conjunction with an adaptive tutorial arrangement, a record is maintained of all past student interactions. This enables modifications to knowledge model aspects (being either changes in global knowledge model protocols, or rules in individual tutorials/tasks) to be retroactively applied. For example, a given tutorial may be initially released without any control instructions that affect changes in knowledge data values, and completed by a set of students. Later, the rules of that tutorial are modified thereby to incorporate knowledge data value modifications. A retroactive application tool may then be used to process data indicative of trap state realised by each of the students in the set at the time of completing the tutorial, thereby to update their knowledge data values retroactively.

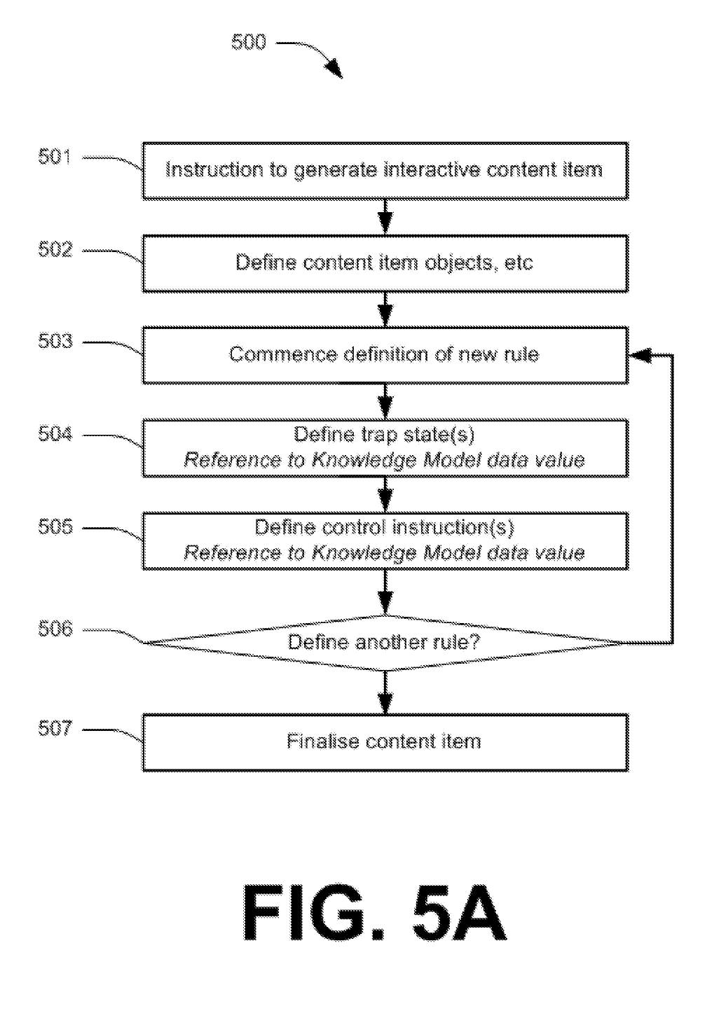

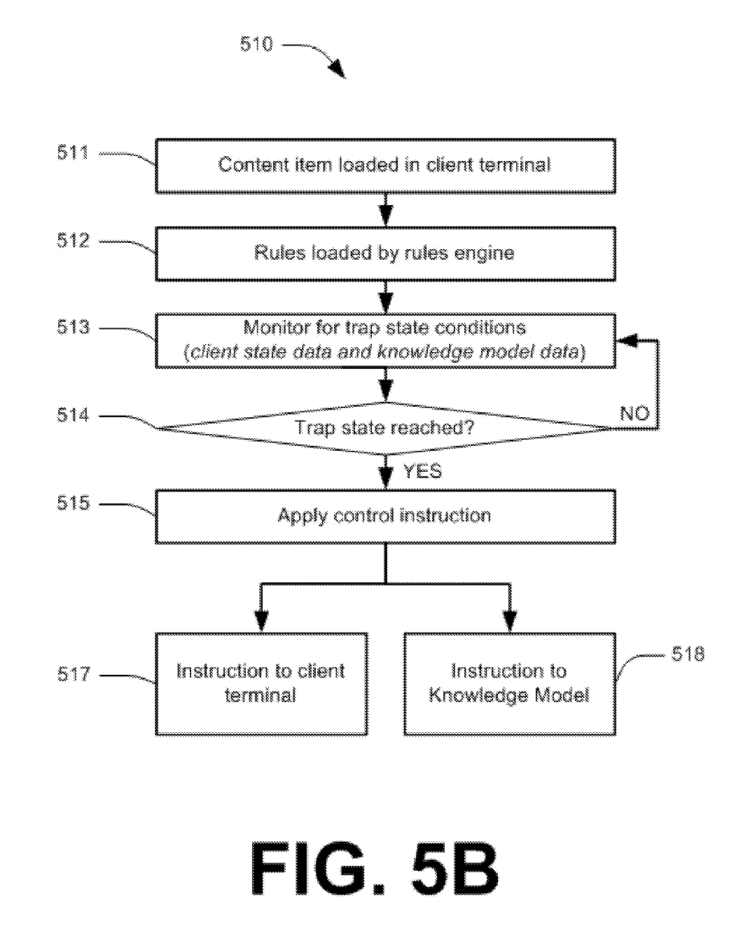

FIG. 5A illustrates an exemplary method 500 for generating an interactive content item (for example part of an adaptive tutorial). An instruction to generate a new interactive content item is received at 501. This may also be an instruction to modify an existing item, or edit a partially completed item. Content item objects and the like are defined at 502. This may include selecting a simulation, defining text, adding objects such as check-boxes and/or response fields, and so on. At 503 the user commences defining a new rule. This includes defining trap states at 504, and one or more of these may include a reference to specific knowledge data values in the knowledge model. Control instructions are defined at 505, and these may also include references to the knowledge model (for example instructions to selectively modify knowledge data values). Although 504 and 505 are shown as being consecutive, it will be appreciated that in practice a user will tend to define a trap state and its associated control instruction prior to defining another trap state. Subject to decision 506, a user either commences definition of another rule at 503 or finalises the content item at 507.

In the context of managing an interactive content item, wherein the interactive content item, an exemplary method includes: monitoring state data at the client terminal; maintaining access to a knowledge model, wherein the knowledge model includes data indicative of a plurality of topic identifiers and, for each topic identifier, a knowledge data value associated with the user; and operating a module thereby to coordinate implementation of one or more rules for the interactive content item. Each rule includes a trap state, which is realized when a set of trap state conditions are satisfied; and a control instruction associated with the trap state, the control instruction being executed in the case that the trap state is realized. This applies in a context whereby, in respect of at least one of the rules, the trap state condition is bound to a first specified knowledge data value defined in a knowledge model, wherein the knowledge model includes data indicative of a plurality of topic identifiers and, for each topic identifier, a knowledge data value associated with the user. Furthermore, at least one of the control instructions includes a command to update a second specified knowledge data value in the knowledge model in a prescribed manner.

FIG. 5B illustrates an exemplary method 501 according to one embodiment. At 511 a content item is loaded at a client terminal. The relevant rule or rules for that content item are then loaded by a rules engine at 512, which monitors for trap state conditions at 513. This include monitoring both client state data and the knowledge model. In some cases relevant knowledge data values are pre-obtained from the knowledge model upon loading of the rules. If a trap state is reached at 514, the relevant control instruction is applied at 515. This may result in either or both of an instruction to the client terminal at 517 (for example feedback or a state change) and an instruction to the knowledge model at 518 (for example an instruction to modify the knowledge data value for a particular topic identifier).

### Mastery Estimation

In some embodiments, a knowledge model approach is used as an enabler for performing estimations in relation to whether a student understands a particular concept. For example, this may be achieved in the following manner.
Data points are created when a student triggers trap-states. These data points are defined so as to provide a form of “mastery evidence”. That is, a tutorial author controls the defining of trap-states and associated control instructions based on whether reaching those trap states represents understanding/misunderstanding of a given concept. In effect, anything the student does on the system (e.g. moves a slider in simulation, comments on the discussion board) can be targeted to create a trap-state and in turn mastery evidence.
A mastery algorithm uses trap-state evidence (i.e. data points) along with other data captured by the system, and optionally any other data external from the system (including external knowledge related data).

It will be appreciated that the effectiveness of the mastery algorithm will be in a sense limited by the quality of trap-states created by an author.

Levels of abstraction can be generated retrospectively, i.e. low-level learning objectives are mapped to trap-states and these can be aggregated up and up to any level of high-level learning objectives. The mastery algorithm may be continually refined as more student data is captured and used to validate the estimates of student understanding (mastery).

Mastery estimation may be leveraged for purposes external of adaptive tutorials, For example when learning objectives have been intelligently mapped to trap-states, a company looking for employees could use the mastery values to find a student that possesses mastery of a unique combination of skills they need for a job.

In some embodiments, trap state to low level objective association is input by an author during the authoring process. Each trap state may generate multiple such associations (for example when a question is relevant to multiple low level objectives, an association is created for each of these low level objectives). The association contains:
Ability: an enum indicating the ability of the student as suggested by the student falling into this trap state. One of {NONE, SOME, GOOD}. If the student gives a correct answer, the corresponding ability is GOOD. If the student gives an incorrect answer, the author must distinguish between the following scenarios:
   NONE: no ability is demonstrated. The student's answer demonstrates no understanding of the low level objective.
   SOME: some understanding of the low level objective is demonstrated, however there is a misconception in the student's understanding of the low level objective.
   GOOD: despite an incorrect answer being given, the author identifies that the answer given by the student demonstrates gets the component of the question corresponding to this low level objective correct.
Relevance: an enum indicating the degree to which falling into that trap state should influence this objective. One of {LOW, HIGH}. Practically, it represents the following:
   if the ability associated with a trap state is GOOD, relevance should represent the proportion of the low level objective exhibited in that question. For example, if a low level objective asks to distinguish between two concepts, and the question corresponds only to one of those concepts, the author should assign LOW relevance.
   If the ability associated with a trap state is not GOOD, relevance should represent the probability that the incorrect answer given was due to a misconception in this particular low level objective. For example, if the question tests only a single low level objective, relevance should be HIGH. If the low level objective which caused an incorrect answer is difficult to identify, the author should assign LOW relevance.
   In both cases, LOW relevance can be assigned if the author is unsure of the ability level inputted.

Each time a student hits a trap state, an evidence point is generated for the student for each of the trap state's associations. An evidence point contains the author-inputted low level objective and level of ability as well as a weight calculated from a set of parameters. Intuitively, the ability is a representation of the student's level of understanding on that question, where the weight represents the degree to which this particular demonstration of understanding should impact the holistic aggregate of student understanding which is reported to the author. That is, weighting is used to control how heavily a given evidence point should weigh into an overall mastery calculation. Weight is a function of the author-inputted relevance for that association, optionally as well as other factors such as when the point was generated and other properties of the question.

The author also creates associations between low level objectives and high level objectives. The author sees the following values for each student and each high level objective:
Understanding: a real number in [0, 1] indicating the system's guess of that user's ability for the objective. May be shown as an integral percentage in [0,100]. Understanding is a function aggregated across the understandings and weights of the student's evidence points for that objective.
Confidence: a real number in [0, 1] indicating the system's confidence in the understanding value it outputs. This value may be shown as an integral percentage in [0,100]. Confidence is a function of consistency, quantity, recency but none of these values are exposed to the author.
Consistency: how consistent the performance of that student's evidence for that objective is. If the student always gets GOOD performance or always gets BAD, the consistency is high, whereas erratic student performance would reduce the consistency value. Consistency is calculated using the sample variance of the performance values of the student's evidence points.
Quantity: how much evidence we have for that student in that objective. Specifically, the sum of weights of all evidence points for the student in that objective. This sum is called total weight.
Recency: how recent is the evidence we have for that student in that objective.

Understanding and confidence are defined and calculated for low level and high level objectives. However, only the values for high level objectives are numerically shown to authors. Values for low level objectives may be shown through other indicators e.g. colour and saturation.

### Exemplary Client-Server Arrangement

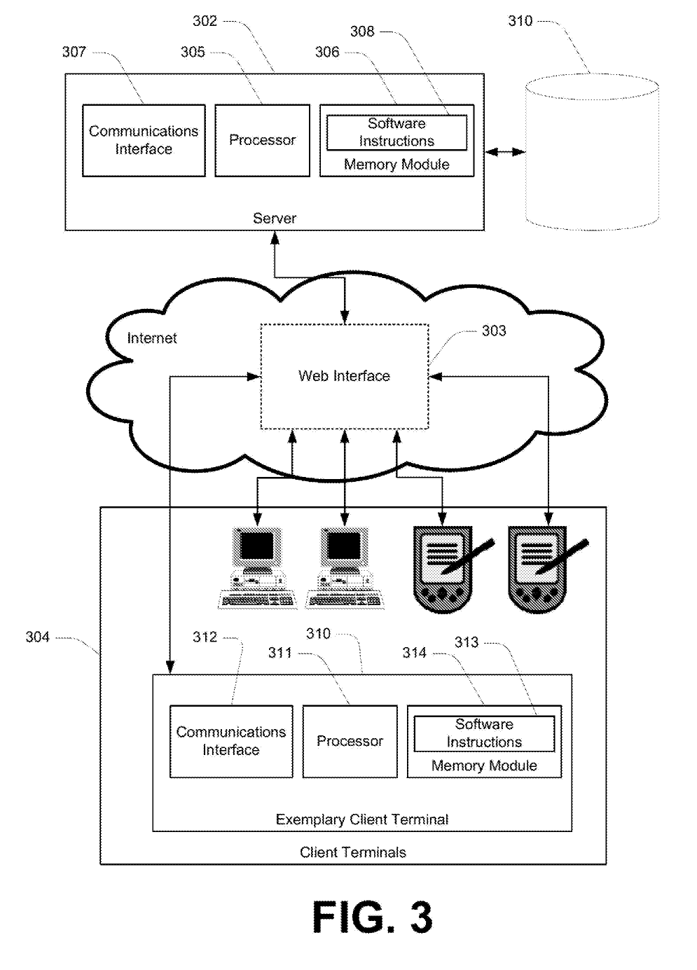

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302.

### Conclusions and Interpretation

It will be appreciated that the disclosure above provides various significant frameworks and methodologies for generating and delivering adaptive tutorials.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for generating an interactive content item, wherein the interactive content item is to be accessed by a user of a client terminal, the method including:
commencing generation of an interactive content item;
defining one or more rules for the interactive content item, wherein each rule includes:
(i) a trap state, which is realized when a set of trap state conditions are satisfied; and
(ii) a control instruction associated with the trap state, the control instruction being executed in the case that the trap state is realized; and
in respect of at least one of the rules, setting a trap state condition that is bound to a first specified knowledge data value defined in a knowledge model, wherein the knowledge model includes data indicative of a plurality of topic identifiers and, for each topic identifier, a knowledge data value associated with the user; and
in respect of at least one of the control instructions, defining a command to update a second specified knowledge data value in the knowledge model in a prescribed manner.

2. A method according to claim 1 wherein the knowledge model includes data indicative of a plurality of topic identifiers and, for each topic identifier:
(i) a knowledge data value associated with the user; and
(ii) respective knowledge data values associated with a plurality of further users.

3. A method according to claim 1 wherein the knowledge model includes data indicative of a plurality of topic identifiers and, for each topic identifier, a knowledge data value associated with the user, wherein each knowledge data value is indicative of the user's determined competency in respect of a topic described by the topic identifier.

4. A method according to claim 1 wherein setting a trap state condition that is bound to a specified first knowledge data value defined in the knowledge model includes any one or more of the following:
setting a trap condition that requires the specified first knowledge data value be greater than a threshold value;
setting a trap condition that requires the specified data first knowledge value be less than a threshold value; and
setting a trap condition that requires the specified data first knowledge value be equal to a threshold value.

5. A method according to claim 1 wherein the first knowledge data value defines the second knowledge data value.

6. A method according to claim 1 wherein each data knowledge data value is numerically defined.

7. A method according to claim 1 wherein the command to update the specified second knowledge data value in the knowledge model in a prescribed manner includes any one or more of the following:
a command to increase/decrease the specified second knowledge data value by a specified quantum;
a command to increase/decrease the specified second knowledge data value by a specified proportion; and
a command to selectively increase/decrease the specified second knowledge data value responsive to its current value.

8. A method according to claim 1 wherein at least one of the control instructions provides one or more of the following functionalities:
provide feedback to the user responsive to the specified first knowledge data value;
modify state data in an environment in which the interactive content item executes; and
direct the user to a specified further interactive content item.

9. A method according to claim 1 wherein the interactive content item is a task defined in an adaptive tutorial.

10. A method according to claim 1 wherein the trap state conditions are defined by reference to either or both of:
(i) simulation state data for a simulation rendered at the client terminal; and
(ii) tutorial state data for an interactive tutorial rendered at the client terminal.

11. A computer implemented method for managing an interactive content item, wherein the interactive content item rendered at a client terminal and accessed by a user, the method including:
monitoring state data at the client terminal;
maintaining access to a knowledge model, wherein the knowledge model includes data indicative of a plurality of topic identifiers and, for each topic identifier, a knowledge data value associated with the user;
operating a module thereby to coordinate implementation of one or more rules for the interactive content item, wherein each rule includes
(i) a trap state, which is realized when a set of trap state conditions are satisfied; and
(ii) a control instruction associated with the trap state, the control instruction being executed in the case that the trap state is realized; and
wherein, in respect of at least one of the rules, the trap state condition is bound to a first specified knowledge data value defined in a knowledge model, wherein the knowledge model includes data indicative of a plurality of topic identifiers and, for each topic identifier, a knowledge data value associated with the user; and
wherein at least one of the control instructions includes a command to update a second specified knowledge data value in the knowledge model in a prescribed manner.

12. A method according to claim 11 wherein the knowledge model includes data indicative of a plurality of topic identifiers and, for each topic identifier:
(i) a knowledge data value associated with the user; and
(ii) respective knowledge data values associated with a plurality of further users.

13. A method according to claim 11 wherein the knowledge model includes data indicative of a plurality of topic identifiers and, for each topic identifier, a knowledge data value associated with the user, wherein each knowledge data value is indicative of the user's determined competency in respect of a topic described by the topic identifier.

14. A method according to claim 11 wherein the a trap state condition that is bound to a specified first knowledge data value defined in the knowledge model includes any one or more of the following:
a trap condition that requires the specified first knowledge data value be greater than a threshold value;
a trap condition that requires the specified data first knowledge value be less than a threshold value; and
a trap condition that requires the specified data first knowledge value be equal to a threshold value.

15. A method according to claim 11 wherein the first knowledge data value defines the second knowledge data value.

16. A method according to claim 11 wherein each data knowledge data value is numerically defined.

17. A method according to claim 11 wherein the command to update the specified second knowledge data value in the knowledge model in a prescribed manner includes any one or more of the following:
a command to increase/decrease the specified second knowledge data value by a specified quantum;
a command to increase/decrease the specified second knowledge data value by a specified proportion; and
a command to selectively increase/decrease the specified second knowledge data value responsive to its current value.

18. A method according to claim 11 wherein at least one of the control instructions provides one or more of the following functionalities:
provide feedback to the user responsive to the specified first knowledge data value;
modify state data in an environment in which the interactive content item executes; and
direct the user to a specified further interactive content item.

19. A method according to claim 11 wherein the interactive content item is a task defined in an adaptive tutorial.

20. A method according to claim 11 wherein the trap state conditions are defined by reference to either or both of:
(i) simulation state data for a simulation rendered at the client terminal; and
(ii) tutorial state data for an interactive tutorial rendered at the client terminal.

21. (canceled)

22. (canceled)

23. (canceled)
